(19) United States
(12) Patent Application Publication
(10) Pub. No.: US 2007/0044612 A1
(43) Pub. Date: Mar. 1, 2007

(54) Gage plate adjustment mechanism for a food slicer

(76) Inventors: Hardev S. Somal, LaPorte, IN (US); Philip Anthony, Chicago, IL (US); Scott J. Rote, New Lenox, IL (US); Frank Bondarowicz, Glenview, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/348,567

(22) Filed: Feb. 7, 2006

Related U.S. Application Data
(60) Provisional application No. 60/711,790, filed on Aug. 26, 2005.

(51) Int. Cl. B26D 1/15

(52) U.S. Cl. 83/247; 83/717

(57) ABSTRACT

A food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade. The base portion includes a food product table slidably secured thereto and is movable across the cutting blade for holding product while it is being sliced by the cutting blade. An adjustable gage plate also is provided for determining the thickness of a food product to be sliced by the cutting blade. A gage plate adjustment mechanism is secured to an upper portion of the upstanding portion and is in direct communication with an upper portion of the gage plate for adjustment of the gage plate by an operator with respect to the cutting blade to determine the thickness of a food product to be sliced.

### CROSS-REFERENCE TO RELATED APPLICATIONS

This application claims benefit of U.S. provisional patent application Ser. No. 60/711,790, filed Aug. 26, 2005, which is herein incorporated by reference.

### TECHNICAL FIELD

The present invention relates generally to food slicers and more particularly to a new design for a gage plate adjustment mechanism for a food slicer that provides for an enhanced sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be quite flexible since they need to handle a variety of products of different shapes and sizes while readily providing different thicknesses of the product being sliced. The speed at which a particular product is moved across the cutting blade also varies on automatic food slicers to improve productivity.

To vary the thickness of the sliced product, an adjustable gage plate and corresponding gage plate adjustment mechanism are provided. An operator typically rotates a knob or the like which moves the gage plate with respect to the cutting blade via the adjustment mechanism to change the slice thickness of the product.

### SUMMARY

In accordance with an embodiment, a food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade.

The base portion includes a food product table slidably secured thereto and is movable across the cutting blade for holding product while it is being sliced by the cutting blade. An adjustable gage plate also is provided for determining the thickness of a food product to be sliced by the cutting blade.

A gage plate adjustment mechanism is secured to an upper portion of the upstanding portion and is in direct communication with an upper portion of the gage plate for adjustment of the gage plate by an operator with respect to the cutting blade to determine the thickness of a food product to be sliced.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a front plan view of the food slicer of FIG. 1;

FIG. 3 is a top perspective view of the support portion of the food slicer of FIGS. 1 and 2;

FIG. 4 is a top view of the gage plate adjustment mechanism of the food slicer of FIGS. 1 and 2 with portions cut away; and

FIG. 5 is a perspective view of a variable pitch screw of the gage plate adjustment mechanism of FIG. 4.

### DETAILED DESCRIPTION

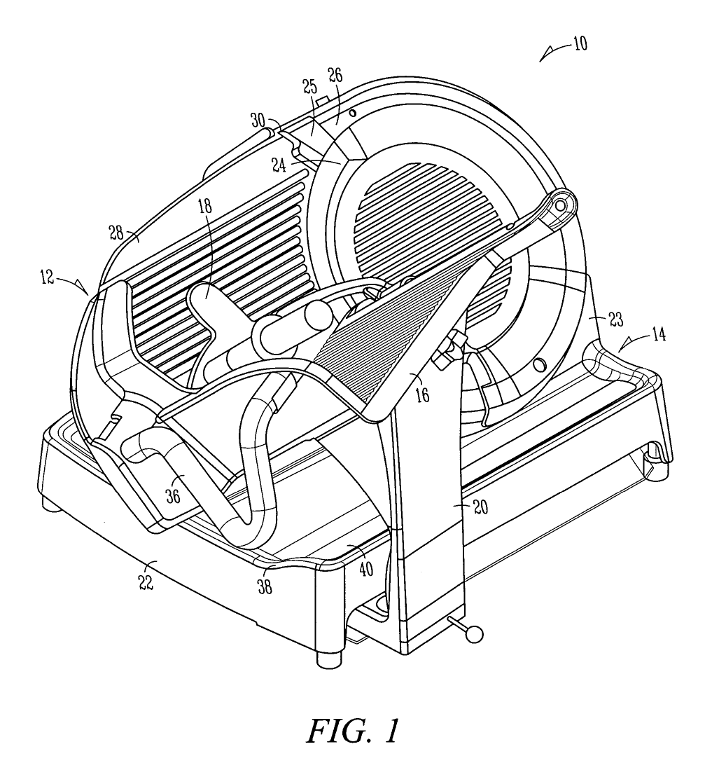

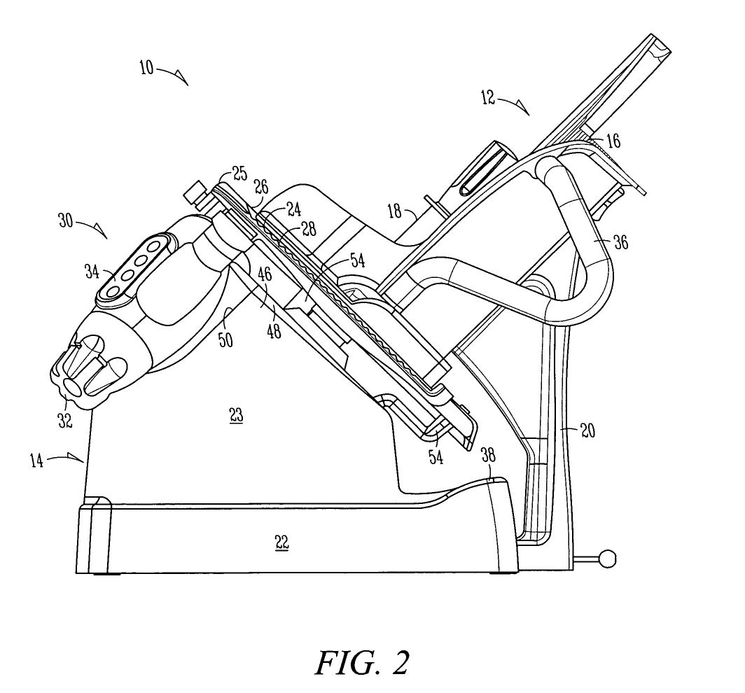

The food slicer of the present invention is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10 of the present invention. The food slicer 10 substantially includes a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 via a handle 36 forward or to the right with respect to FIG. 1 whereby the blade 24 slices the product to the desired thickness. The operator then pulls the product table 16 backward or to the left with respect to FIG. 1 for continued slicing of the product as described above.

The gage plate adjustment mechanism 32 and controls 34 of the operator interface 30 are mounted to the upstanding portion 23 above the base portion 22 of the support portion 14 and up and out of the way of the plane of slicing and thus away from the path of the food product. By mounting the operator interface 30 in this way, the support portion 14 may further be free of control buttons, knobs or the like and provides for easy access to such controls thereby contributing to a more ergonomic design.

The support portion 14 is formed to substantially include the base portion 22 and the upstanding portion 23 and is substantially a strong and durable hollow shell. The support portion 14 preferably is integrally formed from a moldable material, such as plastic or the like. It is to be understood, however, that the particular material utilized can vary and may include stainless steel, aluminum or any other material desired and can be manufactured by any method desired.

The base portion 22 essentially acts as a catch area for the food product as it is sliced from the blade 24 where an operator can catch the food product with a hand and stack it onto the base portion 22 or onto a piece of paper or plastic placed thereon or merely let the food product fall onto the base portion 22. The base portion 22 preferably includes an outer lip 38 about its periphery substantially forming a basin to contain the food, scraps, juices or the like which fall to the base portion 22 during or after slicing.

Additionally, the base portion 22 preferably has a sloped edge portion 40 formed on the edge opposite the upstanding portion 23 and a substantially flat area 42. The sloped edge portion 40 serves to direct food, scraps, juices or the like to the flat area 42 of the base portion 22 for easy removal and cleaning.

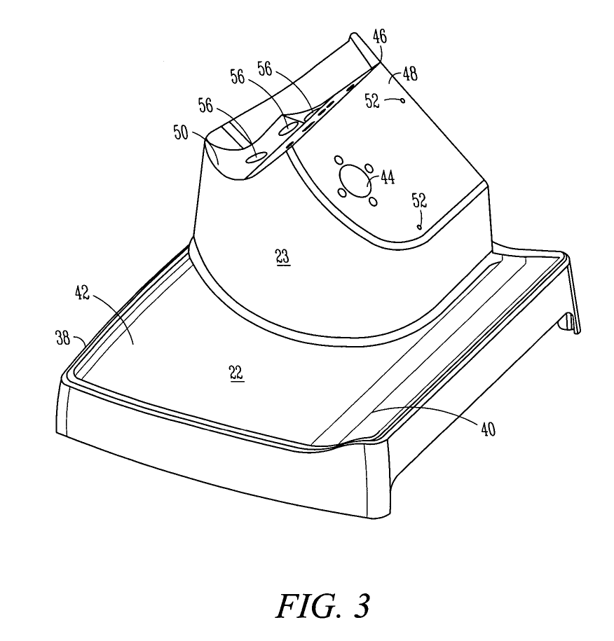

With reference to FIG. 3, the upstanding portion 23 is integrally formed with the base portion 22 and provides a mounting structure or housing for the food slicer 10. On the underside of the upstanding portion 23 and base portion 22, various components including the blade motor and other desired mechanisms may be housed.

The upstanding portion 23 includes a knife mounting aperture 44 for connection to and driving of the blade 24 and is completely sealed with appropriate gaskets or the like to prevent food scraps and juices from going therethrough. The aperture 44 is positioned toward a front edge of the upstanding member 23 so that the arc of engagement between the blade 24 and the food product falls in front of the upstanding member 23 and food scraps and the like are directed away from the aperture 44.

The upstanding member 23 also is formed with upstanding side walls that terminate at a distal end 46 having a first top surface 48 and a second top surface 50. The first top surface 48 preferably is a substantially planar surface that serves as a location to mount the ring guard 25 which supports the knife cover 26, such as at points 52 which can be through-holes that accept a bolt and a corresponding nut or threaded apertures that may or may not extend through the first top surface 48. The threaded apertures 52 preferably receive a standoff 54 or the like which seals the apertures 52 from byproducts as illustrated in FIG. 2. Alternatively, the standoffs 54 can be integrally formed with the first top surface 48 and include a threaded aperture at their distal ends (not illustrated) for fastening of the ring guard 25 thereto.

As FIGS. 2 and 3 illustrate, the second top surface 50 of the upstanding portion 23 substantially is formed as a recess within which the operator interface 30 is mounted and sealed with respect to the upstanding portion 23 such as with a gasket or the like (not illustrated). The second top surface 50 also may include one or more apertures 56 therein for mounting of the operator interface 30 to the upstanding member 23 and for communicating electrical and mechanical control wires, cables, or other members (not illustrated) therethrough to the operator interface 30.

It is to be noted that the base member 22 and upstanding member 23 of the support portion 14 beneath the first and second top surfaces 48 and 50 are formed as a single continuous piece with a total continuous surface with no openings, seams, crevices or the like. This “one piece body” design reduces contamination beneath the top surfaces 48 and 50 and enables easier, faster cleaning of the food slicer 10. In fact, applicant has conducted an independent study confirming the same.

It is to be noted that the operator interface 30 is positioned on the upstanding member 23 up and away from the blade 24, outside or behind the arc of engagement and out of the way of the direct path of food scraps and juices that generally fall vertically from the blade 24, while still in a location convenient for the operator. Due to the positioning of the operator interface 30 and second top surface 50 up and away from the blade 24 and first top surface 48, food scraps and juices do not tend to accumulate near the operator interface 30 and second top surface 50. Although it is not illustrated in the drawings, if desired the first top surface 48 can be designed and integrally formed to extend upward and to the left with respect to FIG. 2 to cover or shield the second top surface 50.

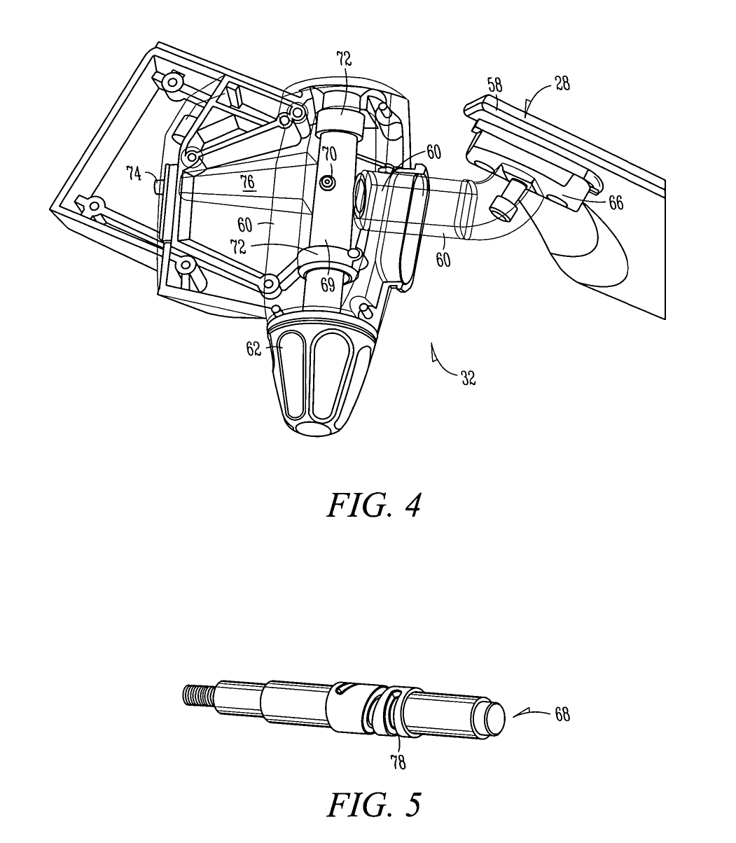

Referring now to FIGS. 2 and 4, the operator interface 30 preferably is positioned beneath the gage plate 28 and is connected to an upper portion 58 of the gage plate 28 by a gage plate support and adjustment arm 60. The operator interface 30 also includes a thickness adjustment knob or index 62 that is positioned adjacent to one or more slicer control buttons generally illustrated by the reference numeral 34 as described above. The number and type of control buttons 34 can vary and typically include an on/off button and one or more speed control buttons for the slicer 10.

To change the thickness of the product being sliced, an operator merely turns the knob 62 as desired which in turn moves the gage plate 28 with respect to the blade 24 thereby changing the size of the slice thickness gap. Typically, rotating the knob 62 counterclockwise (or away from the operator) as viewed in FIG. 2 from the left side of the slicer 10 widens the thickness gap to provide for a thicker slice of food product while rotating the knob 62 clockwise narrows the thickness gap to provide for a thinner slice of food product, but can vary.

As FIG. 4 generally illustrates, the gage plate adjustment mechanism 32 is directly attached to the side of the gage plate 28 at a single location opposite the product table 16 and food product being sliced. The components of the gage plate adjustment mechanism 32 substantially include the adjustment knob 62, the gage plate support arm 60, a gage plate attachment and alignment mechanism 66, a variable pitch screw 68 (see FIG. 5) within a portion 69 of the support arm 60, a pin 70, precision bushings 72, a slider block 74 and a stabilizer 76. The slider block 74 may be designed to provide an additional adjustment of the gage plate 28 in a direction substantially normal to the plane of FIG. 4 if needed, although this feature is not illustrated in the drawings.

Briefly, the gage plate support arm 60 is guided and controlled by the variable pitch screw 68 and bushings 72 which are held in the support arm 60 by the design of the housing of the support arm 60 or similar method. By rotating the knob 62, the variable pitch screw 68 is activated and the pin 70 that is attached to the support arm 60 rides in the thread 78 of the screw 68 thereby moving the gage plate 28.

The variable pitch screw 68 allows for the fine adjustment of the gage plate 28 for thin slicing and coarse adjustment of the gage plate for larger slices of food product. As an example, the thread 78 on the variable pitch screw 68 can be formed so that the first full revolution of the knob 62 may only result in the gage plate 28 opening ⅜ths of an inch while the second revolution of the knob 62 may result in the gage plate 28 opening and additional 1 inch. It is to be understood, however, that the particular pitch of the screw 68 can vary.

The variable pitch screw 68 is designed to withstand all of the loads expect for the torsion around its centerline. To withstand this torsion and constrain the gage plate from rotating about the axis of the screw 68, the stabilizer 76 is provided the design of which can vary.

The slider block 74 or similar component can remove backlash in the adjustment mechanism while reducing the amount that the gage plate 28 rocks about the axis of the variable pitch screw 68. The gage plate attachment and alignment mechanism 66 provides for alignment of the gage plate 28 with respect to the blade 24 both in manufacturing and in the field and provides both rotational and translational adjustment of the gage plate 28. A spring member (not illustrated) may also be included to completely eliminate any rocking. The gage plate 28 can rock slightly about the axis of the variable pitch screw 68 without impacting the quality of the slice of the food product although the weight of the gate plate 28 biases the entire assembly in a generally downward direction.

It is to be noted that the position of the gage plate support and adjustment mechanism 32 enables an operator to make adjustment with a left hand while the controls 34 and knob 62 are in the operator's line of sight. It also eliminates a potential pinch point with the product table support arm 20 or other member of the slicer 10.

Additionally, the position and design of the gage plate support and adjustment mechanism 32 provides for a larger size of the opening between the gage plate 28 and blade 24 enabling a wider variety of product thicknesses since the knob 62 will not contact another portion of the slicer 10 as it is rotated counterclockwise or outward. The limit to the size of this opening is determined merely by how far out the knob 62 is to extend outward.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
a motor positioned within said upstanding portion for rotating said cutting blade;
a food product table secured to said base portion and movable across said cutting blade for holding product while being sliced by said cutting blade;
an adjustable gage plate secured to said upstanding portion for determining the thickness of a food product to be sliced by said cutting blade; and
a gage plate adjustment mechanism secured to an upper portion of said upstanding portion and in direct communication with an upper portion of said gage plate for adjustment of said gage plate by an operator with respect to said cutting blade to determine the thickness of a food product to be sliced.

2. The food slicer as defined in claim 1, wherein said gage plate adjustment mechanism includes a variable pitch screw mechanism.

3. The food slicer as defined in claim 1, wherein said gage plate includes a first top surface facing said food product and a second bottom surface opposite said first top surface and said gage plate adjustment mechanism is connected to said gage plate on said bottom surface.

4. The food slicer as defined in claim 2, wherein said gage plate adjustment mechanism acts in a direction substantially parallel to the movement of the variable pitch screw mechanism.

5. The food slicer as defined in claim 1, wherein said gage plate adjustment mechanism is connected to said gage plate at a single location.

6. The food slicer as defined in claim 1, wherein said gage plate adjustment mechanism is positioned adjacent at least one control member of the slicer.

7. A gage plate adjustment mechanism for a food slicer, comprising:
a thickness adjustment mechanism for adjustment by an operator; and
a member for attachment of the gage plate adjustment mechanism and the thickness adjustment mechanism to an upper portion of a gage plate in direct communication with the gage plate for adjustment of the gage plate with respect to a cutting blade of the food slicer upon adjustment of the thickness adjustment mechanism by an operator to determine the thickness of a food product to be sliced.

8. The gage plate adjustment mechanism as defined in claim 7, wherein said gage plate adjustment mechanism includes a variable pitch screw mechanism

9. The gage plate adjustment mechanism as defined in claim 7, wherein said gage plate includes a first top surface facing said food product and a second bottom surface opposite said first top surface and said gage plate adjustment mechanism is connected to said gage plate on said bottom surface.

10. The gage plate adjustment mechanism as defined in claim 8, wherein said gage plate adjustment mechanism acts in a direction substantially parallel to the movement of said variable pitch screw mechanism.

11. The gage plate adjustment mechanism as defined in claim 7, wherein said gage plate adjustment mechanism is connected to said gage plate at a single location.

12. The gage plate adjustment mechanism as defined in claim 7, wherein said thickness adjustment mechanism is adjacent at least one control member of the slicer.
